(19) United States
(12) Patent Application Publication
(10) Pub. No.: US 2026/0079133 A1
(43) Pub. Date: Mar. 19, 2026

(54) INJECTION VALVE

(71) Applicant: INSCINSTECH CO., LTD., Suzhou (CN)

(72) Inventors: Dawei LI, Suzhou (CN); Guanghua YANG, Suzhou (CN); Qian YANG, Suzhou (CN)

(73) Assignee: INSCINSTECH CO., LTD., Suzhou (CN)

(21) Appl. No.: 19/365,223

(22) Filed: Oct. 22, 2025

Related U.S. Application Data
(63) Continuation of application No. PCT/CN2025/113165, filed on Aug. 7, 2025.

(30) Foreign Application Priority Data
Sep. 5, 2024 (CN) 2024/11243855.7

(51) Int. Cl. G01N 30/20; F16K 3/08

(52) U.S. Cl. CPC G01N 30/20; F16K 3/08; G01N 2030/201; G01N 2030/202

(57) ABSTRACT

An injection valve, which includes a stator and a rotor, where the stator provides a first through hole, a second through hole, a third through hole, a fourth through hole, a fifth through hole, a sixth through hole, a seventh through hole, and an eighth through hole, an inner stator surface is provided with a stator groove, an inner rotor surface is provided with a first rotor groove, a second rotor groove, a third rotor groove, a fourth rotor groove, and a fifth rotor groove, and the fifth rotor groove includes a first sub-groove and a second sub-groove connected to the first sub-groove.

### CROSS REFERENCE TO RELATED APPLICATIONS

This application is a continuation application of International Application No. PCT/CN2025/113165, filed on Aug. 7, 2025, which is based upon and claims foreign priority to Chinese patent Application No. 202411243855.7, the entire contents of which are incorporated herein by reference.

### TECHNICAL FIELD

The present disclosure relates to the fields of protein purification, nucleic acid synthesis, liquid chromatography, and the like, and in particular, to an injection valve for functions such as sample loading.

### BACKGROUND

The high-performance liquid chromatograph (HPLC) is an instrument that separates various substances to be separated based on the differences in affinity such as partition coefficients and adsorption capacities of the substances in two phases, followed by detection using a detector such as ultraviolet.

During HPLC operation, sometimes air will ingress into the chromatographic column and the detector, resulting in the failure of the chromatographic column or abnormal detection results. In addition, during HPLC operation, different types of sample pumps generally need to be selected according to the detection requirements and the number of samples, so the sample pumps and the connected pipelines often need to be disassembled and installed and replaced, the operation is tedious, and a large amount of air will be mixed in the disassembled and installed pipelines, which leads to the failure of the chromatographic column or abnormal detection results.

### SUMMARY

In order to overcome the above shortcomings of the prior art, the present disclosure provides an injection valve with a flushing function and capable of switching between different types of sample pumps.

An objective of the present disclosure is to provide an injection valve, which includes a stator (10) and a rotor (20), the rotor being rotatable relative to the stator about a rotation axis, where the stator is provided with an inner stator surface and an outer stator surface, the stator is provided with a first through hole (1), a second through hole (2), a third through hole (3), a fourth through hole (4), a fifth through hole (5), a sixth through hole (6), a seventh through hole (7), and an eighth through hole (8) penetrating through the inner stator surface and the outer stator surface, the inner stator surface is provided with a stator groove (5a), the first through hole, the second through hole, the third through hole, the fourth through hole, the fifth through hole, and the eighth through hole are sequentially disposed on a circle centered on the rotation axis and having a first radius (R1), the sixth through hole and the seventh through hole are sequentially disposed on a circle centered on the rotation axis and having a second radius (R2), one end of the stator groove coincides with the fifth through hole, and the other end (5b) of the stator groove extends to the circle of the second radius;
the rotor comprises an inner rotor surface hermetically engaged with the inner stator surface, the inner rotor surface is provided with a first rotor groove (a), a second rotor groove (b), a third rotor groove (c), a fourth rotor groove (d), and a fifth rotor groove, the fifth rotor groove comprises a first sub-groove (e-1) and a second sub-groove (e-2) connected to the first sub-groove, the first rotor groove (a), the second rotor groove (b), and the second sub-groove (e-2) are spaced apart from each other, two ends of the first rotor groove (a), two ends of the second rotor groove (b), and two ends of the second sub-groove (e-2) are separately located on the circle of the first radius (R1) and the circle of the second radius (R2), the third rotor groove (c), the fourth rotor groove (d), and the first sub-groove (e-1) are spaced apart from each other, and two ends of the third rotor groove (c), two ends of the fourth rotor groove (d), and two ends of the first sub-groove (e-1) are all located on the circle of the first radius (R1).

In some embodiments, when the rotor rotates to a first state, the first rotor groove connects the second through hole (2) with the sixth through hole (6), and the second rotor groove (b) connects the first through hole (1) with the stator groove (5a).

In some embodiments, when the rotor rotates to a second state, the first sub-groove (e-1) of the fifth rotor groove connects the first through hole (1) with the second through hole (2), the first rotor groove (a) connects the eighth through hole (8) with the seventh through hole (7), and the third rotor groove (c) connects the third through hole (3) with the fourth through hole (4).

In some embodiments, when the rotor rotates to a third state, the third rotor groove (c) connects the first through hole (1) with the second through hole (2), the second rotor groove connects the fifth through hole (5) with the seventh through hole (7), and the fourth rotor groove (d) connects the third through hole (3) with the fourth through hole (4).

In some embodiments, when the rotor rotates to a fourth state, the third rotor groove (c) connects the second through hole (2) with the third through hole (3), the fifth rotor groove connects the seventh through hole (7) with the first through hole (1), and the fourth rotor groove (d) connects the fifth through hole (5) with the fourth through hole (4).

In some embodiments, the first through hole is configured to be connected to a chromatographic column, the second through hole is configured to be connected to a system pump, the third through hole and the seventh through hole are configured to be connected to a sample loop, the fourth through hole and the sixth through hole are respectively configured to be connected to a waste reservoir, and the eighth through hole and the fifth through hole are respectively configured to be connected to a first sample pump and a second sample pump.

In some embodiments, the first rotor groove (a), the second rotor groove (b), and the second sub-groove (e-2) are all linear grooves.

In some embodiments, the third rotor groove (c), the fourth rotor groove (d), and the first sub-groove (e-1) are all arc grooves, and the arc grooves are located on the circle of the first radius.

In some embodiments, the first radius is greater than the second radius.

In some embodiments, the injection valve further includes: a driving member connected to the rotor; and a controller connected to the driving member and configured to control, in response to a flushing instruction from a user, the driving member to drive the rotor to rotate around the rotation axis to the first state.

According to the present disclosure, through the layout of the respective through holes and the grooves of the stator and the rotor, the rotor can realize the functions of flushing and switching between different types of sample pumps when rotating relative to the stator, thereby meeting the detection requirements and the detection precision.

### BRIEF DESCRIPTION OF THE DRAWINGS

The accompanying drawings described herein, which are provided to provide a further understanding of the present disclosure, constitute a part of the present disclosure. The exemplary embodiments of the present disclosure and the description thereof are provided to illustrate the present disclosure and do not constitute undue limitations on the present disclosure. In the drawings:

FIG. 1A illustrates a schematic diagram of an inner stator surface according to some embodiments of the present disclosure;

FIG. 1B illustrates a schematic diagram of an outer stator surface according to some embodiments of the present disclosure;

FIG. 1C illustrates a schematic diagram of a layout of through holes and stator grooves in a stator according to some embodiments of the present disclosure;

FIG. 2A illustrates a schematic diagram of a rotor according to some embodiments of the present disclosure;

FIG. 2B illustrates a schematic diagram of a layout of grooves on an inner rotor surface according to some embodiments of the present disclosure;

FIG. 3A illustrates a schematic diagram of a flow path of an injection valve in a first state according to some embodiments of the present disclosure;

FIG. 3B illustrates a schematic diagram of the cooperation between a stator and a rotor of an injection valve in a first state according to some embodiments of the present disclosure;

FIG. 4A illustrates a schematic diagram of a flow path of an injection valve in a second state according to some embodiments of the present disclosure;

FIG. 4B illustrates a schematic diagram of the cooperation between a stator and a rotor of an injection valve in a second state according to some embodiments of the present disclosure;

FIG. 5A illustrates a schematic diagram of a flow path of an injection valve in a third state according to some embodiments of the present disclosure;

FIG. 5B illustrates a schematic diagram of the cooperation between a stator and a rotor of an injection valve in a third state according to some embodiments of the present disclosure;

FIG. 6A illustrates a schematic diagram of a flow path of an injection valve in a fourth state according to some embodiments of the present disclosure; and

FIG. 6B illustrates a schematic diagram of the cooperation between a stator and a rotor of an injection valve in a fourth state according to some embodiments of the present disclosure.

### DETAILED DESCRIPTION OF THE EMBODIMENTS

To make the objectives, technical solutions, and advantages of embodiments of the present application clearer, the technical solutions in the embodiments of the present application will be clearly and completely described below with reference to the drawings in the embodiments of the present application. It is evident that the described embodiments are some, but not all embodiments of the present application.

Therefore, the following detailed description of the embodiments of the present application provided in the drawings is not intended to limit the scope of the present disclosure as claimed, but merely represents selected embodiments of the present application. Based on the embodiments in the present application, all other embodiments obtained by those of ordinary skill in the art without creative efforts shall fall within the protection scope of the present application.

It should be noted that similar reference numerals and letters refer to similar items in the following drawings, and thus, once an item is defined in one figure, it need not be further defined or explained in the subsequent drawings.

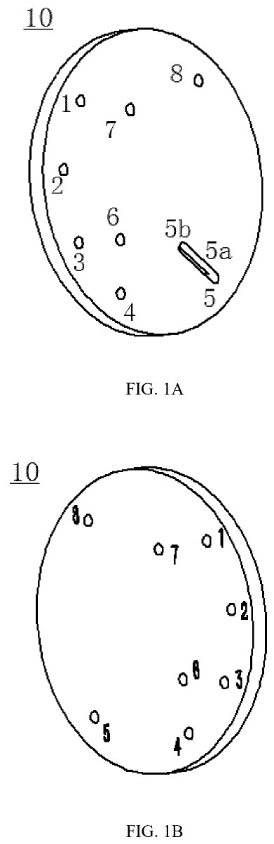

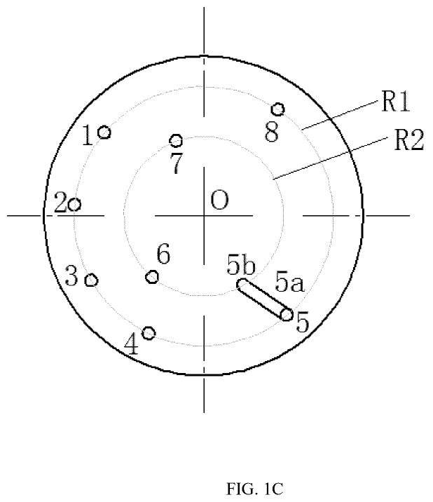

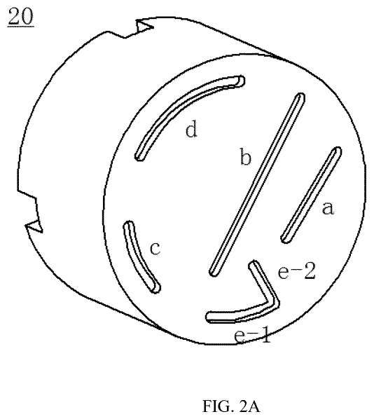

Hereinafter, the present disclosure will be described in detail with reference to FIGS. 1A to 6B.

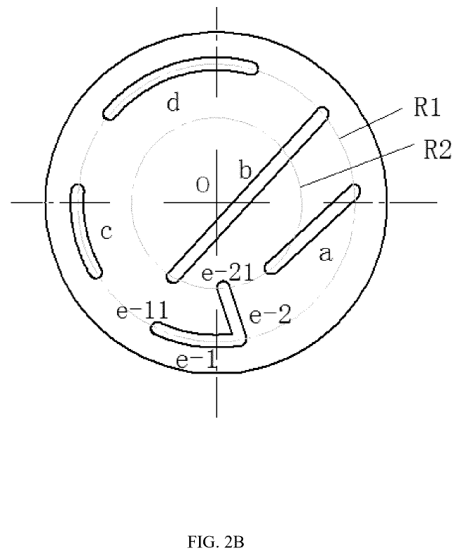

The present disclosure provides an injection valve, which includes a stator 10 and a rotor 20, where the rotor 20 is rotatable around a rotation axis O relative to the stator 10, the stator 10 is provided with an inner surface (a surface shown in FIG. 1A) of the stator and an outer surface (a surface shown in FIG. 1B) of the stator, the rotor 20 is provided with an inner surface (a surface with grooves shown in FIG. 2A) of the rotor, and the inner rotor surface is hermetically engaged with the inner stator surface.

A surface of the rotor 20 opposite to the inner stator surface is the inner rotor surface. The hermetical engagement between the inner rotor surface and the inner stator surface may be formed in such a manner that the inner rotor surface and the inner stator surface abut against each other with a specific compression force therebetween.

For example, the stator 10 and the rotor 20 may be respectively in a cylindrical shape or a disc shape, and dimensions of the two may be similar. The rotation axis O of the rotor 20 may pass through the center of the stator 10 and the rotor 20 (the center of a circle). Certainly, shapes of the stator 10 and the rotor 20 may alternatively be other shapes, such as, square and prismatic.

As shown in FIGS. 1A and 1B, the stator 10 is provided with a first through hole 1, a second through hole 2, a third through hole 3, a fourth through hole 4, a fifth through hole 5, a sixth through hole 6, a seventh through hole 7, and an eighth through hole 8 that penetrate through the inner stator surface and the outer stator surface, and the inner stator surface is provided with a stator groove 5A. As shown in FIG. 1C, the first through hole 1, the second through hole 2, the third through hole 3, the fourth through hole 4, the fifth through hole 5 and the eighth through hole 8 are sequentially disposed on a circle centered on the rotation axis O and having a first radius R1, the sixth through hole 6 and the seventh through hole 7 are sequentially disposed on a circle centered on the rotation axis O and having a second radius R2, one end of the stator groove 5A coincides with the open end of the fifth through hole 5 on the inner stator surface, and the other end 5B of the stator groove 5A extends to the circle of the second radius R2.

The circle having the first radius R1 (shown in FIG. 1C) and the circle having the second radius R2 (shown in FIG. 1C) are both imaginary circles. In other words, they serve as design baselines and are introduced for illustrative purposes, not as real circles. Certainly, the above-mentioned circle may be marked on the inner stator surface 10. The first radius R1 may be greater than the second radius R2.

One end of the stator groove 5A coinciding with the open end of the fifth through hole 5 on the inner stator surface and the other end 5B of the stator groove 5a extending to the circle of the second radius R2 may be understood in such a way that the stator groove 5A is a groove with a specific groove depth, and two ends of the stator groove 5A are respectively located on the circle of the first radius R1 and the circle of the second radius R2. The end located on the circle of the first radius R1 coincides with the open end of the fifth through hole 5 on the inner stator surface, and is connected to the open end of the fifth through hole 5 on the outer stator surface via the fifth through hole 5 that penetrates through the inner stator surface and the outer stator surface.

Referring to FIGS. 2A and 2B, the inner rotor surface is provided with a first rotor groove a, a second rotor groove b, a third rotor groove c, a fourth rotor groove d, and a fifth rotor groove, the fifth rotor groove includes a first sub-groove e-1 and a second sub-groove e-2 connected to the first sub-groove e-1, the first rotor groove a, the second rotor groove b, and the second sub-groove e-2 are spaced apart from each other, two ends of the first rotor groove a, two ends of the second rotor groove b, and two ends of the second sub-groove e-2 are separately located on the circle of the first radius R1 and the circle of the second radius R2, the third rotor groove c, the fourth rotor groove d, and the first sub-groove e-1 are spaced apart from each other, and two ends of the third rotor groove c, two ends of the fourth rotor groove d, and two ends of the first sub-groove e-1 are all located on the circle of the first radius R1.

The first rotor groove a, the second rotor groove b, and the second sub-groove e-2 being spaced apart from each other means that the first rotor groove a, the second rotor groove b, and the second sub-groove e-2 are not connected to each other. The third rotor groove c, the fourth rotor groove d, and the first sub-groove e-1 being spaced apart from each other means that the third rotor groove c, the fourth rotor groove d, and the first sub-groove e-1 are not connected to each other.

The fifth rotor groove including the first sub-groove e-1 and the second sub-groove e-2 connected to the first sub-groove e-1 means that both the first sub-groove e-1 and the second sub-groove e-2 are provided with a free end and a connection end, which are respectively a free end e-11 (shown in FIG. 2b) of the first sub-groove e-1 and a free end e-21 (shown in FIG. 2B) of the second sub-groove e-2. Both the free end e-11 and the connection end of the first sub-groove e-1 are located on the circle of the first radius R1, and the free end e-21 of the second sub-groove e-2 is located on the circle of the second radius R2.

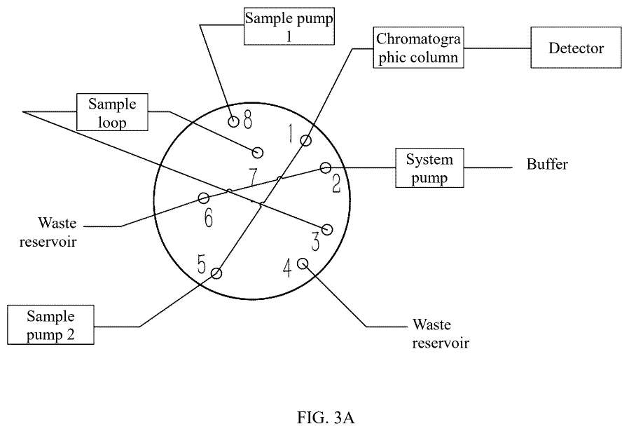

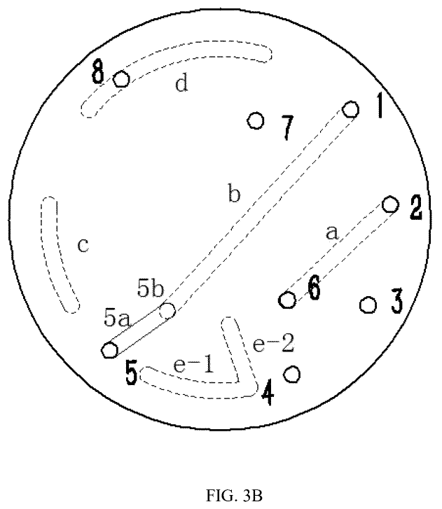

Referring to FIGS. 3A, 4A, 5A, and 6A, the first through hole 1 may be configured to be connected to a chromatographic column, the chromatographic column is connected to a detector, the second through hole 2 may be configured to be connected to a system pump, the system pump is connected to a buffer storage for pumping a buffer, the third through hole 3 and the seventh through hole 7 may be configured to be connected to a sample loop, the fourth through hole 4 and the sixth through hole 6 may be respectively configured to be connected to a waste reservoir, and the fifth through hole 5 and the eighth through hole 8 may be respectively configured to be connected to a sample pump. For example, the eighth through hole 8 is connected to a sample pump 1, the fifth through hole 5 is connected to a sample pump 2, and the sample pump 1 and the sample pump 2 may be different types of sample pumps.

Referring to FIGS. 3A and 3B, when the injection valve is in the first state, the first rotor groove a connects the second through hole 2 with the sixth through hole 6, and at the same time, the second rotor groove b connects the first through hole 1 with the stator groove 5A. Thus, the buffer is sucked into the pipeline by the system pump at a relatively large flow rate, is discharged to the second through hole 2 by the system pump, flows into the sixth through hole 6 through the first rotor groove a, and flows into the waste reservoir to realize the flushing (PURGE) function; at the same time, the sample pump 2 injects the sample into the fifth through hole 5, and the sample flows into the first through hole 1 through the stator groove 5a and the second rotor groove b, and enters the chromatographic column and the detector to realize the direct injection function of the sample pump 2, thereby realizing the simultaneous operation of two flow paths.

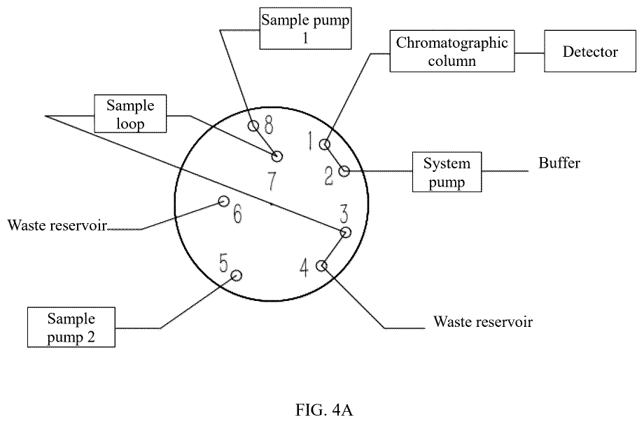

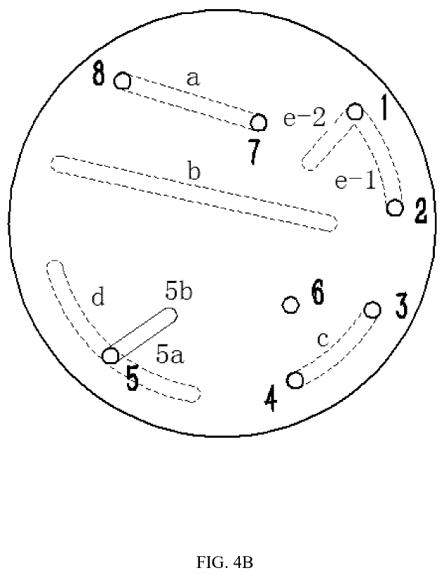

Referring to FIGS. 4A and 4B, when the injection valve is in the second state, the first sub-groove e-1 of the fifth rotor groove connects the first through hole 1 with the second through hole 2, and at the same time, the first rotor groove a connects the eighth through hole 8 with the seventh through hole 7, and the third rotor groove c connects the third through hole 3 with the fourth through hole 4. Thus, the buffer is sucked into the pipeline by the system pump, is discharged to the second through hole 2 after passing through the system pump, is discharged from the first through hole 1 through the first sub-groove e-1, and enters the chromatographic column and the detector, thereby completing the baseline detection of the system and the preparation work of the experiment; at the same time, the sample pump 1 injects the sample into the eighth through hole 8, and the sample flows into the seventh through hole 7 through the first rotor groove a and flows into the sample loop, flows out from the sample loop to the third through hole 3, flows into the fourth through hole 4 through the third rotor groove c, and finally flows out to the waste reservoir, thereby completing the work of loading the sample from the sample pump 1. Thus, the simultaneous operation of the two flow paths is realized.

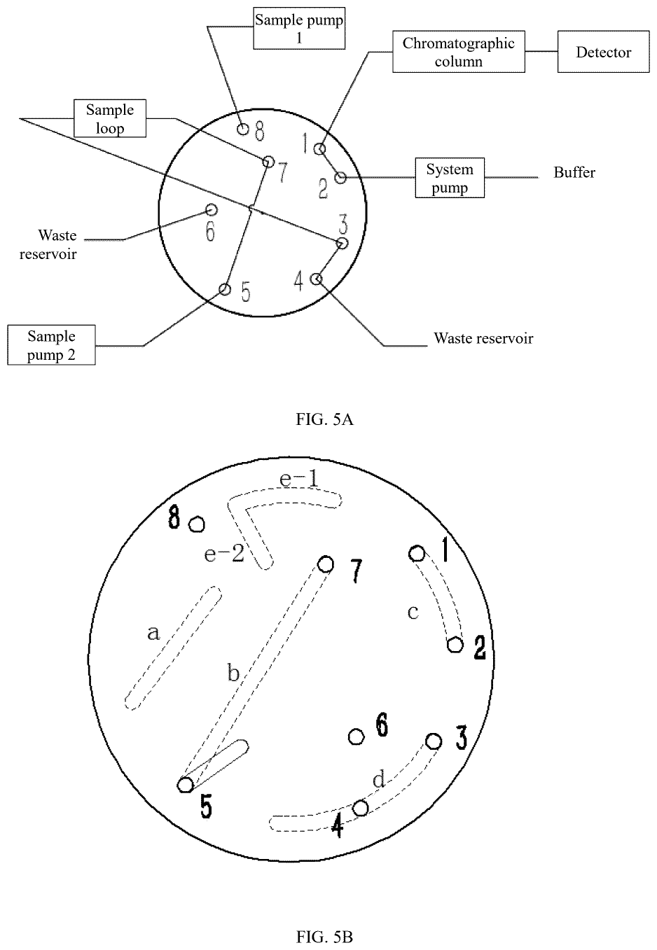

Referring to FIGS. 5A and 5B, when the injection valve is in the third state, the third rotor groove c connects the first through hole 1 with the second through hole 2, the second rotor groove b connects the fifth through hole 5 with the seventh through hole 7, and at the same time, the fourth rotor groove d connects the third through hole 3 with the fourth through hole 4. Thus, the buffer is sucked into the pipeline by the system pump, is discharged to the second through hole 2 after passing through the system pump, enters the first through hole 1 through the third rotor groove c, and enters the chromatographic column and the detector from the first through hole 1, thereby completing the baseline detection of the system and the preparation work of the experiment; at the same time, the sample pump 2 injects the sample into the fifth through hole 5, and the sample enters the seventh through hole 7 through the second rotor groove b, flows out from the seventh through hole 7 to the sample loop, flows out from the sample loop to the third through hole 3, flows into the fourth through hole 4 through the fourth rotor groove d, and finally flows out from the fourth through hole 4 to the waste reservoir, thereby completing the work of loading the sample from the sample pump 2. Thus, the simultaneous operation of the two flow paths is realized.

The sample pump 2 and the sample pump 1 may be sample pumps in different forms (for example, different output flow rates). According to detection requirements, the sample pump 1 or the sample pump 2 is selected to load the sample by switching the injection valve to the second state or the third state, which is more flexible.

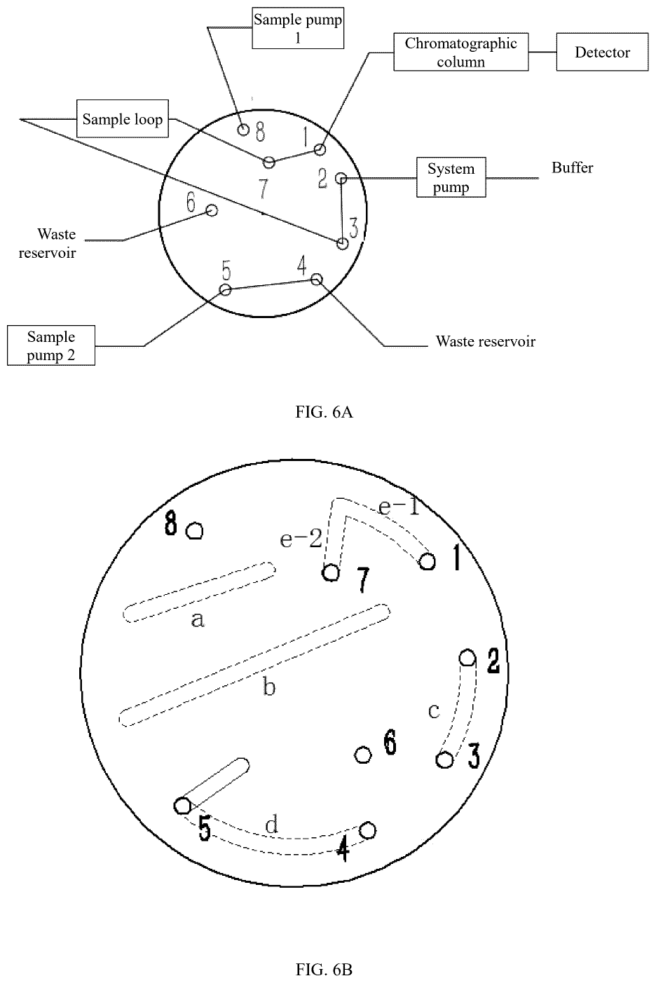

Referring to FIGS. 6A and 6B, when the injection valve is in a fourth state, the third rotor groove c connects the second through hole 2 with the third through hole 3, and the fifth rotor groove connects the seventh through hole 7 with the first through hole 1. Specifically, the free end of the second sub-groove e-2 is in communication with the seventh through hole 7, and the free end of the first sub-groove e-1 is in communication with the first through hole 1, and at the same time, the fourth rotor groove d connects the fifth through hole 5 with the fourth through hole 4. Therefore, the buffer is sucked into the pipeline by the system pump, is discharged to the second through hole 2 after passing through the system pump, and enters the third through hole 3 through the third rotor groove c. After being discharged from the third through hole, the buffer pushes the sample in the sample loop to flow and enter the seventh through hole 7, and then enter the first through hole 1 through the fifth rotor groove. After being discharged from the first through hole 1, the sample under the push of buffer enters the chromatographic column and the detector to complete the injection into the chromatographic column. At the same time, the sample pump 2 injects the medium into the fifth through hole 5, and the medium flows into the fourth through hole 4 through the fourth rotor groove d, so as to flow out to the waste reservoir to complete the cleaning of the flow path, thereby realizing the simultaneous operation of the two flow paths.

Through the layout of the respective through holes and grooves of the stator and the rotor, functions such as flushing and switching between different types of sample pumps can be realized when the rotor rotates relative to the stator, so as to meet various detection requirements without disassembly of components such as pipelines, which is convenient and flexible and helps to improve the detection precision.

In some embodiments, the stator groove 5A, the first rotor groove a, the second rotor groove b, and the second sub-groove e-2 are all linear grooves.

The linear groove facilitates machining and improvement of machining precision, thereby improving manufacturing efficiency and reliability.

Certainly, the shape of one or more of the stator groove 5A, the first rotor groove a, the second rotor groove b, and the second sub-groove e-2 may be non-linear, and can be of such as an arc shape, a curved shape, a broken line shape, or other shapes.

In some embodiments, the third rotor groove c, the fourth rotor groove d, and the first sub-groove e-1 are all arc grooves, and the arc grooves are located on the circle of the first radius R1.

The arc groove facilitates reliable machining by using the circle of the first radius R1 as a reference, and also facilitates improvement of machining precision, thereby improving manufacturing efficiency and reliability.

Certainly, the shape of one or more of the third rotor groove c, the fourth rotor groove d and the first sub-groove e-1 may not be an arc shape, for example, may be a straight line shape, a curved line shape, a broken line shape, or other shapes, and may also not be required to lie on the circle of the first radius R1.

In some embodiments, the injection valve further includes: a driving member (not shown) connected to the rotor 20; and a controller (not shown) connected to the driving member, where the controller is configured to control, in response to a flushing instruction, the driving member to drive the rotor to rotate around the rotation axis O to the first state of the injection valve, such that the first rotor groove a connects the second through hole 2 with the sixth through hole 6, and the second rotor groove b connects the stator groove 5A with the first through hole 1.

Therefore, when the flushing function is selected, the injection valve can be automatically switched to the first state, thereby avoiding serious consequences such as system overpressure and damage to components such as the chromatographic column and the detector caused by forgetting to switch to the first state.

The driving member may be a driving component such as a stepping motor that can drive the rotor 20 to rotate around the rotation axis O.

For example, the controller is further connected to the system pump, and the controller is configured to control, in response to a flushing instruction, the system pump to operate at an output power higher than that of the sample pump, such that the gas can be efficiently and thoroughly discharged, and the detection precision can be improved.

It should be noted that, relational terms such as “first” and “second” as used herein are merely used to distinguish one entity or operation from another entity or operation without necessarily requiring or implying any actual relationship or order between such entities or operations. Moreover, the terms “includes”, “including”, or any other variation thereof, are intended to encompass a non-exclusive inclusion, such that a process, method, item, or device that includes a list of elements does not include only those elements but also include other elements not expressly listed or elements inherent to such process, method, item, or device. Without further limitation, an element defined by the phrase “including a . . . ” does not exclude the presence of additional identical elements in the process, method, item, or device that includes the element.

What is claimed is:

1. An injection valve, comprising a stator and a rotor, the rotor being rotatable relative to the stator about a rotation axis, wherein
the stator is provided with an inner stator surface and an outer stator surface, the stator is provided with a first through hole, a second through hole, a third through hole, a fourth through hole, a fifth through hole, a sixth through hole, a seventh through hole, and an eighth through hole penetrating through the inner stator surface and the outer stator surface, the inner stator surface is provided with a stator groove, the first through hole, the second through hole, the third through hole, the fourth through hole, the fifth through hole, and the eighth through hole are sequentially disposed on a circle centered on the rotation axis and having a first radius (R1), the sixth through hole and the seventh through hole are sequentially disposed on a circle centered on the rotation axis and having a second radius (R2), one end of the stator groove coincides with the fifth through hole, and the other end of the stator groove extends to the circle of the second radius;
the rotor comprises an inner rotor surface hermetically engaged with the inner stator surface, the inner rotor surface is provided with a first rotor groove, a second rotor groove, a third rotor groove, a fourth rotor groove, and a fifth rotor groove, the fifth rotor groove comprises a first sub-groove and a second sub-groove connected to the first sub-groove, the first rotor groove, the second rotor groove, and the second sub-groove are spaced apart from each other, two ends of the first rotor groove, two ends of the second rotor groove, and two ends of the second sub-groove are separately located on the circle of the first radius (R1) and the circle of the second radius (R2), the third rotor groove, the fourth rotor groove, and the first sub-groove are spaced apart from each other, and two ends of the third rotor groove, two ends of the fourth rotor groove, and two ends of the first sub-groove are all located on the circle of the first radius (R1).

2. The injection valve according to claim 1, wherein
when the rotor rotates to a first state, the first rotor groove connects the second through hole with the sixth through hole, and the second rotor groove connects the first through hole with the stator groove.

3. The injection valve according to claim 2, wherein
when the rotor rotates to a second state, the first sub-groove of the fifth rotor groove connects the first through hole with the second through hole, the first rotor groove connects the eighth through hole with the seventh through hole, and the third rotor groove connects the third through hole with the fourth through hole.

4. The injection valve according to claim 3, wherein
when the rotor rotates to a third state, the third rotor groove connects the first through hole with the second through hole, the second rotor groove connects the fifth through hole with the seventh through hole, and the fourth rotor groove connects the third through hole with the fourth through hole.

5. The injection valve according to claim 4, wherein
when the rotor rotates to a fourth state, the third rotor groove connects the second through hole with the third through hole, the fifth rotor groove connects the seventh through hole with first through hole, and the fourth rotor groove connects the fifth through hole with fourth through hole.

6. The injection valve according to claim 1, wherein
the first through hole is configured to be connected to a chromatographic column, the second through hole is configured to be connected to a system pump, the third through hole and the seventh through hole are configured to be connected to a sample loop, the fourth through hole and the sixth through hole are respectively configured to be connected to a waste reservoir, and the eighth through hole and the fifth through hole are respectively configured to be connected to a first sample pump and a second sample pump.

7. The injection valve according to claim 1, wherein
the first rotor groove, the second rotor groove, and the second sub-groove are all linear grooves.

8. The injection valve according to claim 7, wherein
the third rotor groove, the fourth rotor groove, and the first sub-groove are all arc grooves, and the arc grooves are located on the circle of the first radius.

9. The injection valve according to claim 1, wherein
the first radius is greater than the second radius.

10. The injection valve according to claim 2, further comprising:
a driving member connected to the rotor; and
a controller connected to the driving member and configured to control, in response to a flushing instruction from a user, the driving member to drive the rotor to rotate around the rotation axis to the first state.

11. The injection valve according to claim 2, wherein
the first rotor groove, the second rotor groove, and the second sub-groove are all linear grooves.

12. The injection valve according to claim 3, wherein
the first rotor groove, the second rotor groove, and the second sub-groove are all linear grooves.

13. The injection valve according to claim 4, wherein
the first rotor groove, the second rotor groove, and the second sub-groove are all linear grooves.

14. The injection valve according to claim 5, wherein
the first rotor groove, the second rotor groove, and the second sub-groove are all linear grooves.

15. The injection valve according to claim 6, wherein
the first rotor groove, the second rotor groove, and the second sub-groove are all linear grooves.

16. The injection valve according to claim 11, wherein
the third rotor groove, the fourth rotor groove, and the first sub-groove are all arc grooves, and the arc grooves are located on the circle of the first radius.

17. The injection valve according to claim 12, wherein
the third rotor groove, the fourth rotor groove, and the first sub-groove are all arc grooves, and the arc grooves are located on the circle of the first radius.

18. The injection valve according to claim 13, wherein
the third rotor groove, the fourth rotor groove, and the first sub-groove are all arc grooves, and the arc grooves are located on the circle of the first radius.

19. The injection valve according to claim 14, wherein
the third rotor groove, the fourth rotor groove, and the first sub-groove are all arc grooves, and the arc grooves are located on the circle of the first radius.

20. The injection valve according to claim 15, wherein
the third rotor groove, the fourth rotor groove, and the first sub-groove are all arc grooves, and the arc grooves are located on the circle of the first radius.
